(19) United States
(12) Patent Application Publication
(10) Pub. No.: US 2011/0136397 A1
(43) Pub. Date: Jun. 9, 2011

(54) Terminal Crimping Method, Terminal Crimping Structure, Terminal Crimping Device, and Electrical Connector

(75) Inventors: Jun Koga, Kanagawa (JP); Ryuichi Komiyama, Tokyo (JP)

(73) Assignee: TYCO ELECTRONICS AMP K. K., Kawasaki-shi, Kanagawa-ken (JP)

(21) Appl. No.: 12/524,407

(22) PCT Filed: Dec. 19, 2007
(86) PCT No.: PCT/JP2007/074374

§ 371 Date: Mar. 29, 2010

(30) Foreign Application Priority Data
Jan. 25, 2007 (JP) 2007-015539

(51) Int. Cl. H01R 4/10; H01R 43/04; H01R 43/042

(52) U.S. Cl. 439/877; 29/882; 29/753

(57) ABSTRACT

A terminal crimping method and terminal crimping device in which friction between an anvil and a crimper is suppressed and a projection is prevented from being formed above a wire barrel where core wires of an electric cable are crimped. The terminal crimping device (40) has the anvil (41) having a placement groove (43) in which a terminal (10) is placed and also has the crimper (42) for pressing the wire barrel (31) of the terminal (10) placed on the anvil (41). The placement groove (43) has a first pressing section (43a) for pressing an effective crimping section (31a) and also has a second pressing section (43bg) for pressing an extension section (31b). The bottom surface of the second pressing section (43b) is formed as a slope surface expanding toward the receptacle (20).

### TECHNICAL FIELD

The present invention relates to a terminal crimping method, terminal crimping structure, terminal crimping device, and electrical connector having the terminal crimping structure, whereby a terminal which includes a wire barrel for crimping a core wire of an electrical wire is crimped to an end portion of the wire.

### BACKGROUND ART

Conventionally, an electrical connector shown in FIG. 5 and FIG. 6 have been known as inventions of the electric connector provided with the above-mentioned terminals (see Patent Document 1).

FIG. 5 is a partially cutaway cross-sectional view showing a waterproof connector according to Patent Document 1. FIG. 6 is a partially cutaway cross-sectional view showing a terminal, which is being inserted into a cavity of the waterproof connector shown in FIG. 5.

A waterproof connector 100 shown in FIG. 5 and FIG. 6 includes multiple terminals 110 (only one terminal is shown in FIG. 5 and FIG. 6) and a connector housing 120 in which the terminals 110 are accommodated.

Each terminal 110 comprises a receptacle portion 111 and a wire connecting portion 112, and is formed by stamping and forming a metal plate.

The receptacle portion 111 is configured to have a substantial box shape to receive a tab provided at the mating connector (not shown). The receptacle portion 111 includes a base plate 113 that extends in the front-rear direction (the horizontal direction of FIG. 5), a pair of side walls 114 that stand up from both side edges in the widthwise direction (the direction perpendicular to the sheet face of FIG. 5) of the base plate 113, and an upper plate 115 that is bent from one of the pair of side walls 114.

The wire connecting portion 112 includes: a wire barrel 116, which extends from the rear end of the base plate 113 and which crimps a core wire S of an electrical wire W; and an insulation barrel 117, which extends from the rear end of the wire barrel 116 and which crimps an insulation portion H of the electrical wire W.

In this situation, in order to ensure electrical and mechanical connections, the wire barrel 116 needs to be crimped to the core wire S in the electrical wire W over the entire length in its inserting/extracting direction (the horizontal direction of FIG. 5). Hence, the core wire S of the electrical wire W is crimped to the wire barrel 116 with its end portion T protruding frontward from the wire barrel 116.

The connector housing 120 is provided with multiple cavities 121 in two stages, namely upper and lower stages, into which the terminals 110 are accommodated, respectively.

On the rear side of multiple cavities 121 in the connector housing 120, there is provided a sealing member fitting portion 123 into which a sealing member 122 of family type is fit and inserted.

The sealing member 122 is provided with multiple through holes 124 that communicate with the cavities 121, respectively. In addition, three lines of lips 125 are arranged at the inner circumferential surface in each of the through holes 124.

Then, in the waterproof connector 100 as shown in FIG. 6, each terminal 110 is inserted into each cavity 121 from each through hole 124 in the sealing member 122. This allows the respective lips 125 of the sealing member 122 to be tight around the electrical wire W of the terminal 110 that has been inserted into the through hole 124, thereby preventing a drop of water from entering the interior of the cavity 121 from the extracting side of the electrical wire W.

It should be noted, however, that in the terminal 110 of the waterproof connector 100, the end portion T of the core wire S of the electrical wire W that has been crimped by the wire barrel 116 protrudes frontward to be exposed from the wire barrel 116. Accordingly, in a case where the end portion T of the core wire S of the electrical wire W protrudes frontward to be exposed from the wire barrel 116, there is a problem that the end portion T will damage the sealing member 122 when the terminal 110 is inserted into the through hole 124 of the sealing member 122. Then, if the sealing member 122 is damaged, tightness between the sealing member 122 and the electrical wire W will be degraded. This will degrade the waterproof property in the cavity 121, when the waterproof connector 100 mates with the mating connector.

Therefore, a terminal shown in FIG. 7 has been proposed to address the above problem.

FIG. 7 is a perspective view showing a terminal in which an end portion of a core wire is protected.

A terminal 130, in which an end portion of a core wire is protected, as shown in FIG. 7, basically has the same configuration as that of the terminal 110, and is formed by stamping and forming a metal plate. However, a retainer engaging portion 137, to be locked by a retainer (not shown) when the core-wire end-portion protected terminal 130 is included in an electrical connector (not shown), is provided at the upper surface of a receptacle portion 136 of the core-wire end-portion protected terminal 130.

Also, a wire barrel 131 of the core-wire end-portion protected terminal 130 is provided with an effective crimping portion 132 that crimps the core wire of the electrical wire W (not shown in FIG. 7), and an extending portion 133 that covers the end portion of the core wire S of the electrical wire W.

The extending portion 133 is arranged on the front side of the effective crimping portion 132. The extending portion 133 is provided with a confirmation hole 134.

The confirmation hole 134 is provided for confirming the position of the end portion of the core wire in the wire barrel 131 with the core wire of the electrical wire W crimped to the wire barrel 131.

Additionally, in the core-wire end-portion protected terminal 130, the effective crimping portion 132 of the wire barrel 131 crimps the core wire of the electrical wire W, and at the same time, the extending portion 133 covers the end portion of the core wire. In this manner, the extending portion 133 covers the end portion of the core wire of the electrical wire W, thereby preventing the end portion of the core wire from protruding frontward to be exposed from the wire barrel 131.

Accordingly, with the core-wire end-portion protected terminal 130, it is possible to prevent the end portion of the core wire from damaging the sealing member 122, when the core-wire end-portion protected terminal 130 is inserted into the sealing member provided in the connector housing of family waterproof type such as the connector housing 120 shown in FIG. 5.

Moreover, after the crimping of the core wire of the electrical wire W to the wire barrel 131 is completed, the position of the end portion of the core wire in the wire barrel 131 is confirmed from the confirmation hole 134 of the extending portion 133. This makes it possible to confirm whether or not the core wire is crimped over the entire length in the inserting/extracting direction of the effective crimping portion 132 (the direction from the left near side to the right far side of FIG. 7).

In this case, the core wire of the electrical wire W is crimped to the wire barrel 131, by pressing the wire barrel 131 with an anvil and a crimper to swage the wire barrel 131 in which the core wire is arranged.

Meanwhile, the length of the wire barrel 131 in the front-rear direction (the direction from the left near side to the right far side of FIG. 7) in the core-wire end-portion protected terminal 130 is longer than the wire barrel 116 in the terminal 110 shown in FIG. 6 by only the provision of the extending portion 133 in its length. If the wire barrel 131 is longer, a greater pressing force is needed for swaging the wire barrel 131 when the core wire of the electric wire W is crimped. Next, if the pressing force exerted from the anvil and the crimper to the wire barrel 131 is greater, a reaction force exerted from the wire barrel 131 to the anvil and the crimper will be greater when the core wire of the electric wire W is crimped. Then, if the reaction force exerted to the anvil and the crimper is greater when the core wire of the electric wire W is crimped, there is a problem that abrasion will be caused with ease at the anvil and the crimper.

Hence, in order to address the above problem, the core wire of the electrical wire W is crimped to the wire barrel 131 by a terminal crimping device 140 shown in FIG. 8.

FIG. 8 is a partially cross-sectional view showing the relationship between a wire barrel of a terminal, and an anvil and a crimper included in the terminal crimping device. FIG. 8 shows a state where the crimping of the core wire of the electrical wire W to the wire barrel 131 is completed.

That is to say, as shown in FIG. 8, the terminal crimping device 140 is provided with an anvil 141 that supports the wire barrel 131 from the bottom side, and a crimper 142 that presses the wire barrel 131 from the top side.

The lower surface of the crimper 142 has a pressing surface 143 that presses the wire barrel 131. As shown in FIG. 8, the pressing surface 143 of the crimper 142 has a portion for pressing the extending portion 133, which is formed as an inclined surface 144 expanding and opening frontward.

When the core wire of the electrical wire (not shown in FIG. 8) is crimped to the wire barrel 131 by the terminal crimping device 140, the extending portion 133 of the wire barrel 131 is deformed along the inclined surface 144 of the pressing surface 143 in the crimper 142 and then an upthrust portion 145 is formed.

Thus, in the terminal crimping device 140, the core wire of the electrical wire W is crimped only to the effective crimping portion 132 in the wire barrel 131, whereas the core wire is not crimped to the extending portion 133 because the upthrust portion 145 is formed. Accordingly, with the use of the terminal crimping device 140, the pressing force needed for crimping the core wire of the electric wire W to the wire barrel 131 can be suppressed, so the reaction force exerted from the wire barrel 131 to the anvil 141 and the crimper 142 can be suppressed.

Therefore, the terminal crimping device 140 is capable of suppressing abrasion caused at the anvil 141 and the crimper 142.
Patent Document 1: JP 2001-143807 A

In this sense, when the core-wire end-portion protected terminal 130 is included in an electric connector, the core-wire end-portion protected terminal 130 is secondarily locked by a retainer (not shown) to prevent the core-wire end-portion protected terminal 130 from coming off from a connector housing (not shown). In such a case, the retainer is disposed above the wire barrel 131 of the core-wire end-portion protected terminal 130, so the front surface of a locking portion (not shown) provided at the retainer locks the rear surface of the retainer engaging portion 137 of the core-wire end-portion protected terminal 130, whereby the rearward movement of the core-wire end-portion protected terminal 130 is prevented.

Meanwhile, in recent years, there has been an increasing need for downsizing the electrical connector and increasing the number of terminals. In order to downsize the electrical connector and increase the number of terminals, it is necessary to make narrow the arrangement pitch between the terminals included in the electrical connector.

However, if the core-wire end-portion protected terminal 130, in which the core wire of the electrical wire is crimped to the wire barrel 131 by the terminal crimping device 140, is applied to an electrical connector in which the arrangement pitch between the terminals is made narrow, the upthrust portion 145 will interfere with the retainer. Next, if the upthrust portion 145 interferes with the retainer, the retainer cannot be pushed to a predetermined position of the housing, resulting in an insufficient lock by means of the retainer for locking the retainer engaging portion 137 in the core-wire end-portion protected terminal 130. Then, if the lock between the retainer and the retainer engaging portion 137 of the core-wire end-portion protected terminal 130 is insufficient, there is a problem that a desired retaining force of the core-wire end-portion protected terminal 130 will not be obtainable by means of the retainer.

Meanwhile, when the core-wire end-portion protected terminal 130 is locked by the retainer, the core-wire end-portion protected terminal 130 is inserted into the housing with the core-wire end-portion protected terminal 130 disposed at a temporary locking position, firstly. In this case, the retainer is located above the wire barrel 131 of the core-wire end-portion protected terminal 130 (at the upper side of FIG. 8). Subsequently, the retainer at the temporary locking position is made to slide downward (to the lower side of FIG. 8) to be disposed at a proper locking position. In this case, the front surface of a engaging portion in the retainer locks the rear surface of the retainer engaging portion 137 of the core-wire end-portion protected terminal 130 to prevent the core-wire end-portion protected terminal 130 from moving rearward. Accordingly, in the sate where the retainer is located at the proper locking position, a space that corresponds to a sliding amount of the retainer that has been made to slide from the temporary locking position to the proper locking position is inevitably created below the wire barrel 131 of the core-wire end-portion protected terminal 130.

The present invention has been made to solve the above problem, and has an object to provide a terminal crimping method and a terminal crimping device, thereby suppressing the generation of abrasion at an anvil and a crimper, and simultaneously preventing the formation of an upthrust portion at the upper part of a wire barrel to which a core wire of the electrical wire is crimped.

In addition, it is another object of the present invention is to provide a terminal crimping structure in which a swelling portion is arranged at the lower part in the wire barrel to which the core wire of the electrical wire is crimped, thereby permitting a retainer to lock with certainty even in a case where the terminal is applied to an electrical connector with a narrow arrangement pitch between the terminals.

Furthermore, it is yet another object of the present invention is to provide an electrical connector with terminals to which the above terminal crimping structure is applied, thereby permitting the arrangement pitch between the terminals to be made small.

### DISCLOSURE OF THE INVENTION

In order to address the above problems, according to an aspect of the present invention, there is provided a terminal crimping method including: mounting a terminal on a mounting groove of an anvil, the terminal including a receptacle portion, an effective crimping portion that crimps a core wire of an electrical wire, and a wire barrel having an extending portion that covers an end portion of the core wire; and pressing the wire barrel by use of a crimper, the mounting groove including a first pressing portion that presses the effective crimping portion and a second pressing portion that presses the extending portion, the bottom surface of the second pressing portion being formed to be an inclined surface expanding and opening toward the receptacle portion side.

In addition, according to another aspect of the present invention, there is provided a terminal crimping structure including a terminal including: a receptacle portion having a retainer engaging portion that protrudes upward; an extending portion that covers an effective crimping portion that crimps a core wire of an electrical wire, and an end portion of the core wire; and a wire barrel that opens upward, wherein: the terminal is mounted on a mounting groove, the core wire of the electrical wire is crimped to the wire barrel by pressing the wire barrel by use of a crimper, the mounting groove includes a first pressing portion that presses the effective crimping portion and a second pressing portion that presses the extending portion, the bottom surface of the second pressing portion is formed to be an inclined surface expanding and opening toward the receptacle portion side, so a swelling portion is formed at a lower part of the extending portion.

Furthermore, according to yet another aspect of the present invention, there is provided a terminal crimping device including: an anvil having a mounting surface on which a terminal is mounted, the terminal including a receptacle portion, and a wire barrel having an effective crimping portion that crimps a core wire of an electric wire and an extending portion that covers an end portion of the core; and a crimper that presses the wire barrel of the terminal mounted on the anvil, the mounting groove including a first pressing portion that presses the effective crimping portion and a second pressing portion that presses the extending portion, the bottom surface of the second pressing portion being formed to be an inclined surface expanding and opening toward the receptacle portion side.

Moreover, there is provided an electrical connector including: a terminal having the above terminal crimping structure; and a housing that secures the terminal.

### BRIEF DESCRIPTION OF THE DRAWINGS

FIG. 1 is a perspective view illustrative of a terminal to which a terminal crimping structure according to an aspect of the present invention is applied;

FIG. 2 is a front cross-sectional view illustrative of the relationship between an anvil and a crimper included in a terminal crimping device according to an aspect of the present invention, and a wire barrel before a core wire is crimped;

FIG. 3 is a side surface partially cutaway cross-sectional view illustrative of the relationship between the anvil and the crimper included in the terminal crimping device illustrated in FIG. 2, and the wire barrel after the core wire is crimped;

FIG. 4 is a perspective view illustrative of a terminal crimping structure according to an aspect of the present invention;

FIG. 5 is a partially cutaway cross-sectional view showing a waterproof connector according to Patent Document 1;

FIG. 6 is a partially cutaway cross-sectional view showing a terminal, which is being inserted into a cavity of the waterproof connector shown in FIG. 5;

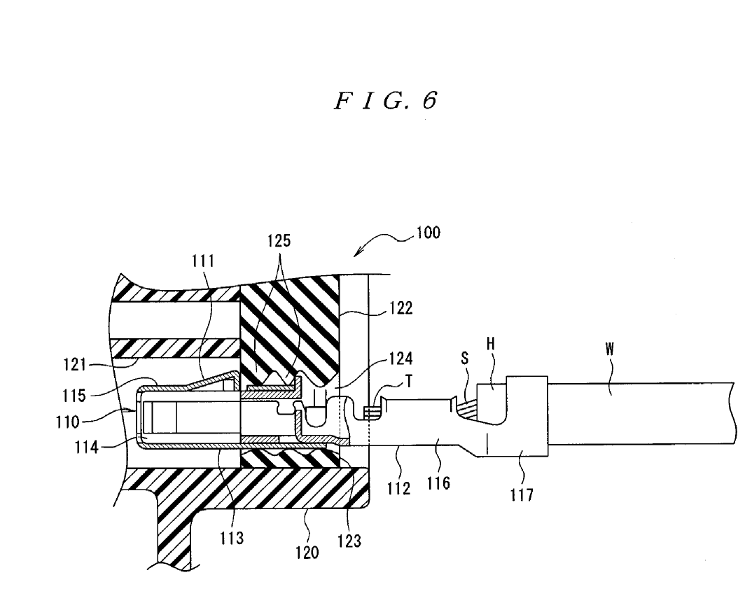

FIG. 7 is a perspective view showing a terminal in which an end portion of a core wire is protected; and

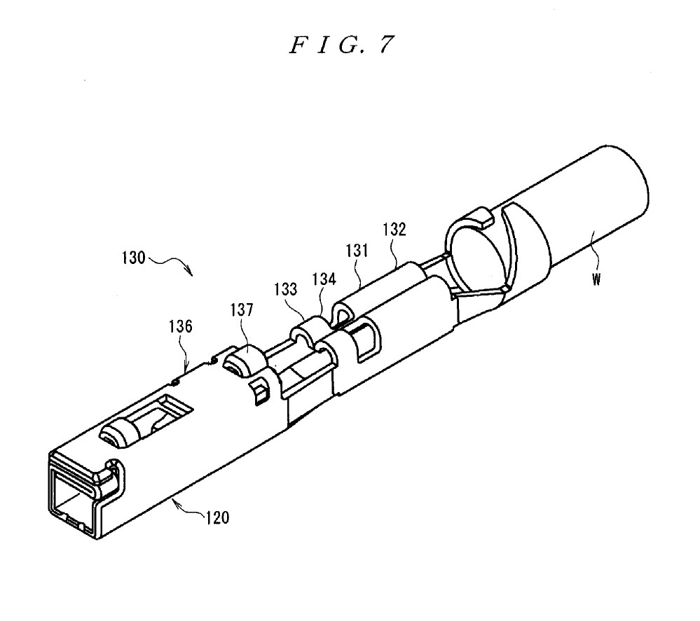

FIG. 8 is a partially cross-sectional view showing the relationship between a wire barrel of a terminal, and an anvil and a crimper included in the terminal crimping device.

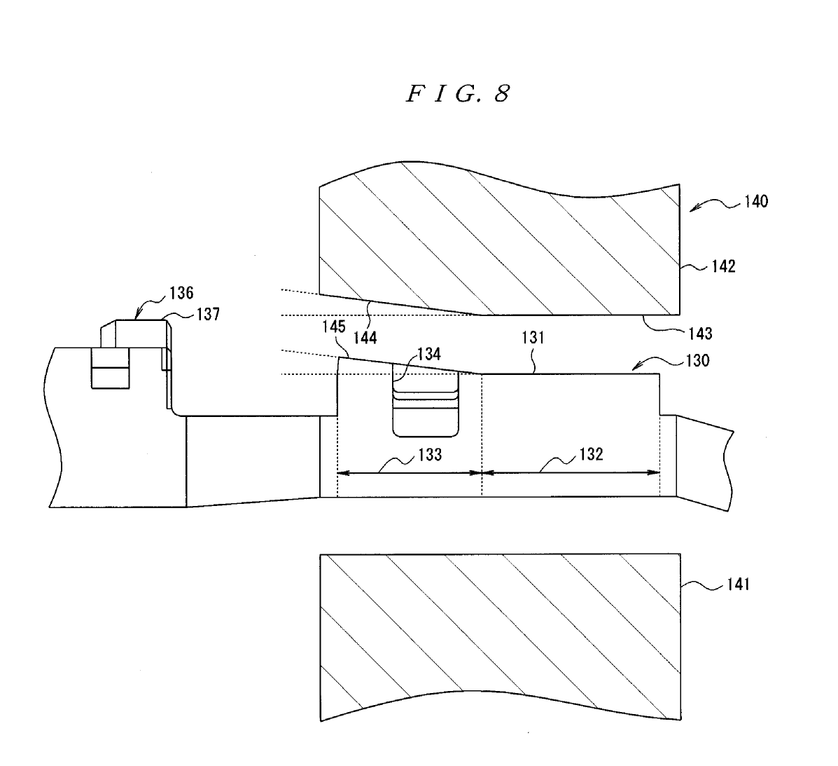

### EXPLANATION OF REFERENCES

1 terminal crimping structure
10 female terminal
20 receptacle portion
C contact carrier
W electrical wire
S core wire
28 retainer engaging portion
30 wire connecting portion
31 wire barrel
31a effective crimping portion
31b extending portion
32 insulation barrel
33 confirmation hole
34a, 34b side walls
35a, 35b side walls
40 terminal crimping device
41 anvil
42 crimper
43 mounting groove
43a first pressing portion
43b second pressing portion
44 pressing groove
45 swelling portion

### BEST MODE FOR CARRYING OUT THE INVENTION

The embodiments of the present invention will now be described with reference to the accompanying drawings.

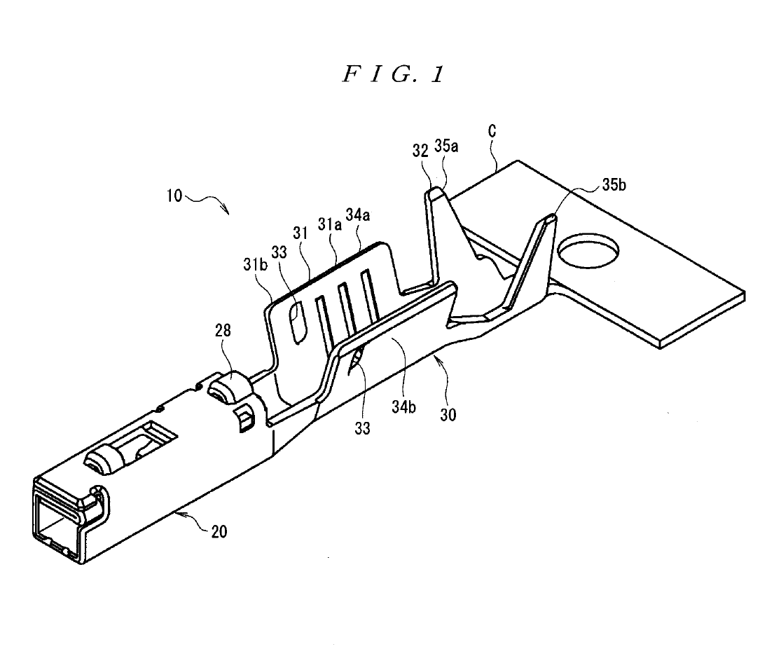

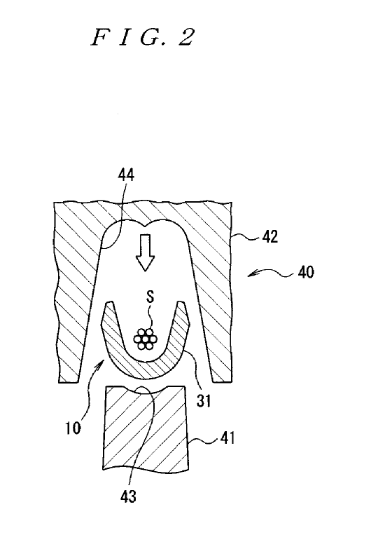

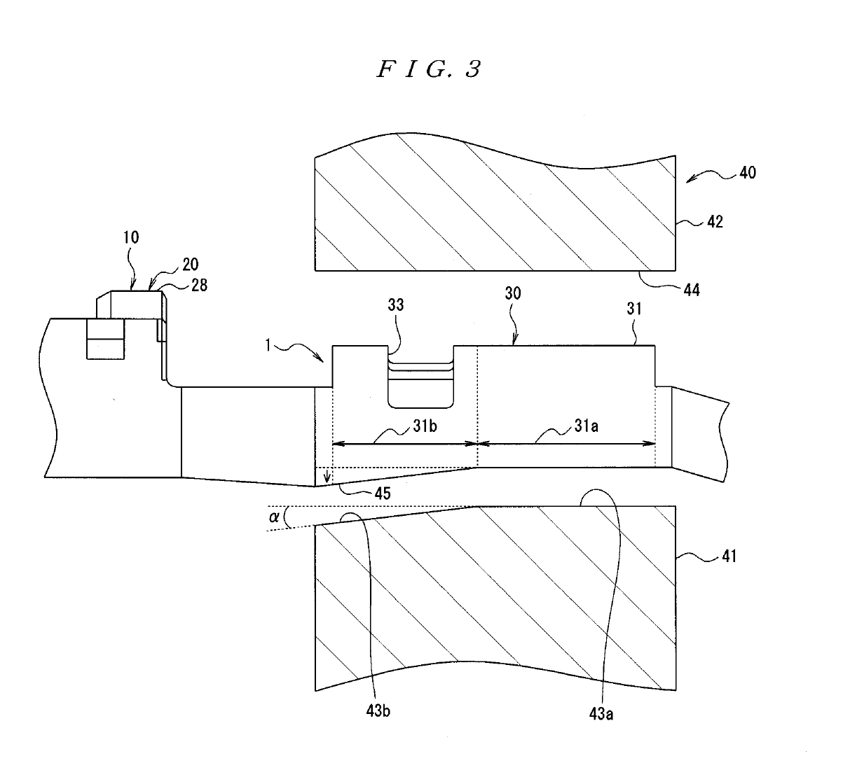

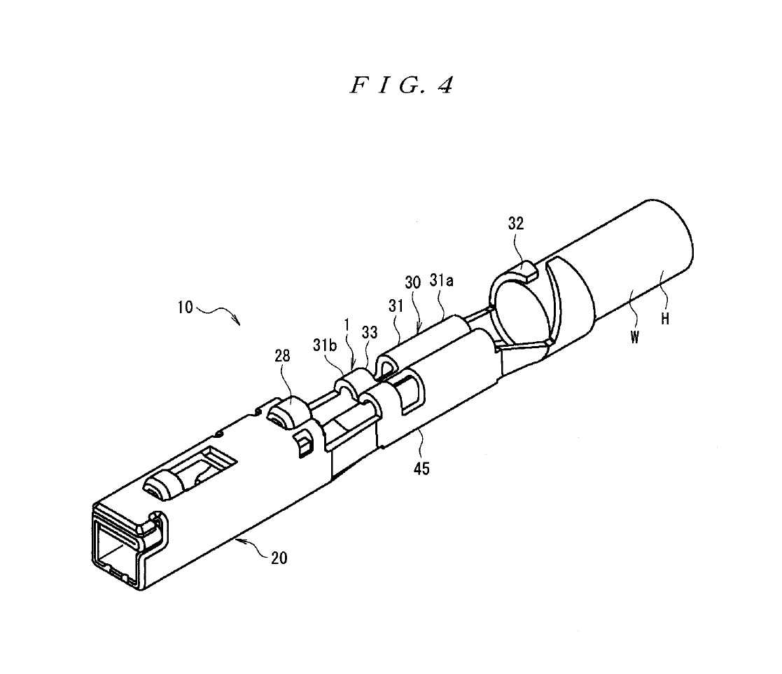

FIG. 1 is a perspective view illustrative of a terminal to which a terminal crimping structure according to an aspect of the present invention is applied. FIG. 2 is a front cross-sectional view illustrative of the relationship between an anvil and a crimper included in a terminal crimping device according to an aspect of the present invention, and a wire barrel before a core wire is crimped. FIG. 3 is a side surface partially cutaway cross-sectional view illustrative of the relationship between the anvil and the crimper included in the terminal crimping device illustrated in FIG. 2, and the wire barrel after the core wire is crimped. FIG. 4 is a perspective view illustrative of a terminal crimping structure according to an aspect of the present invention. Incidentally, in FIG. 3, the electrical wire that is crimped to the terminal is omitted. Also, in FIG. 4, the core wire that is crimped to the wire barrel is omitted.

A terminal crimping structure 1 according to an aspect of the present invention is applicable to a terminal or the like included in an electrical connector. In addition, the terminal crimping structure 1 is applicable to any of a male terminal or a female terminal.

According to the present embodiment, a description will be given of a case where the terminal crimping structure 1 is applied to the female terminal for use in the electrical connector.

A female terminal (terminal) 10 to which the terminal crimping structure 1 is applied is provided with: a receptacle portion 20; and an electrical wire connecting portion 30, as illustrated in FIG. 1, and is formed by stamping and forming a metal plate.

Incidentally, the female terminal 10 is connected to a contact carrier C in FIG. 1, but is to be cut off from the contact carrier C after processing.

The receptacle portion 20, as illustrated in FIG. 1, is formed to have a substantial box shape to receive a male contact (not illustrated) included in the mating connector (not illustrated). A retainer engaging portion 28 to be locked by a retainer (not illustrated), when the female terminal 10 is included in the electrical connector (not illustrated) is provided to protrude upward at a rear end portion, in the front-rear direction, of the upper surface of the receptacle portion 20 (the direction from the left near side to the right far side of FIG. 1). Hereinafter, the left near side will be referred to as front side, and the right far side will be referred to as rear side.

The electrical wire connecting portion 30, as illustrated in FIG. 1, is provided with: a wire barrel 31, which is arranged at the rear side of the receptacle portion 20 and which crimps the core wire S (refer to FIG. 2) of the electrical wire W (refer to FIG. 4); and an insulation barrel 32, which is arranged at the rear side of the wire barrel 31 and which crimps the insulation portion H of the electrical wire W.

The wire barrel 31 includes a pair of side walls 34a and 34b that open upward. The wire barrel 31 also includes: an effective crimping portion 31a that crimps the core wire S of the electrical wire W; and an extending portion 31b that covers the end portion of the core wire S of the electrical wire W. Herein, the bottom surface of the wire barrel 31 is formed to extend as a straight line in the front-rear direction, connecting the effective crimping portion 31a and the extending portion 31b. Also, upper end surfaces of the side walls 34a and 34b extend in parallel to the bottom surface of the wire barrel 31 extending in the front-rear direction.

The effective crimping portion 31a swages both of the side walls 34a and 34b, thereby crimping the core wire S of the electrical wire W. In the state where the core wire S of the electrical wire W is crimped in the effective crimping portion 31a, desired electrical and mechanical properties are ensured at the crimped part where the effective crimping portion 31a and the core wire S are crimped.

The extending portion 31b is arranged at the front side of the effective crimping portion 31a. The extending portion 31b covers the end portion of the core wire S of the electrical wire W by swaging both of the side walls 34a and 34b. In this case, the extending portion 31b does not crimp the core wire S of the electrical wire W. In addition, the extending portion 31b prevents the end portion of the core wire S from protruding frontward to be exposed from the wire barrel 31, with the core wire S of the electrical wire W crimped to the wire barrel 31. A confirmation hole 33 is arranged at the effective crimping portion 31a side of the extending portion 31b in the front-rear direction of the side walls 34a and 34b. The confirmation hole 33 is provided for confirming the position of the end portion of the core wire S in the wire barrel 31, with the core wire S of the electrical wire W crimped to the wire barrel 31. That is to say, the confirmation hole 33 permits confirming of the position of the end portion of the core wire S of the electrical wire W in the wire barrel 31 from the upper side thereof, with both of the side walls 34a and 34b of the extending portion 31b swaged.

The insulation barrel 32 opens upward, and includes a pair of side walls 35a and 35b. The insulation barrel 32 crimps the insulation portion H of the electrical wire W by swaging both of the side walls 35a and 35b.

Next, a description will be given of a terminal crimping device 40 that crimps the electrical wire W to the female terminal 10 to form the terminal crimping structure 1.

The terminal crimping device 40, as illustrated in FIG. 2 and FIG. 3, is provided with: an anvil 41 on which the female terminal 10 is mounted; and a crimper 42 which presses the wire barrel 31 of the female terminal 10 mounted on the anvil 41 from the upper side (the upper side of FIG. 2 and FIG. 3).

The upper surface of the anvil 41 is provided with a mounting groove 43, as illustrated in FIG. 2, on which the female terminal 10 is mounted and which extends in the front-rear direction (the depth direction of FIG. 2, the horizontal direction of FIG. 3).

The mounting groove 43 includes, as illustrated in FIG. 3, a first pressing portion 43a that presses the effective crimping portion 31a; and a second pressing portion 43b that presses the extending portion 31b, in the wire barrel 31 of the female terminal 10 that is mounted.

The bottom surface of the first pressing portion 43a, as illustrated in FIG. 3, is formed to extend horizontally, when viewed in the horizontal direction (the horizontal direction of FIG. 2, the depth direction of FIG. 3).

The bottom surface of the second pressing portion 43b is formed to be an inclined surface expanding and opening toward the receptacle portion 20 side when viewed in the horizontal direction, as illustrated in FIG. 3. Herein, it is possible to set an angle α, which is defined by an extension from the bottom surface of the second pressing portion 43b and another extension from the bottom surface of the first pressing portion 43a, not to exceed 45 degrees. Specifically, it is preferable to set the angle between 3 to 6 degrees.

The crimper 42 is arranged to be movable upward and downward with respect to the anvil 41. The bottom surface of the crimper 42 has a pressing groove 44 opposite to the mounting groove 43 of the anvil 41 with each other, as illustrated in FIG. 2.

The top surface of the pressing groove 44 is formed to extend in parallel to the first pressing portion 43a of the mounting groove 43 in the anvil 41, when viewed in the horizontal direction, as illustrated in FIG. 3.

Next, a description will be given of an operation of crimping the electrical wire W to the female terminal 10 by use of the terminal crimping device 40 to form the terminal crimping structure 1.

Firstly, as illustrated in FIG. 2, the female terminal 10 is mounted on the mounting groove 43 of the anvil 41. In this situation, the effective crimping portion 31a of the wire barrel 31 is disposed on the first pressing portion 43a, and simultaneously the extending portion 31b is disposed on the second pressing portion 43b.

Herein, the bottom surface of the wire barrel 31 is formed to extend as a straight line in the front-rear direction, with connecting the effective crimping portion 31a and the extending portion 31b. On the other hand, the bottom surface of the second pressing portion 43b of the mounting groove 43 in the anvil 41 is formed to be an inclined surface expanding and opening toward the receptacle portion 20 side, when viewed in the horizontal direction. Accordingly, when the female terminal 10 is mounted on the mounting groove 43 of the anvil 41, the bottom surface of the effective crimping portion 31a and that of the first pressing portion 43a are brought into contact with each other, whereas the bottom surface of the extending portion 31b and that of the second pressing portion 43b create a gap therebetween.

Next, the electrical wire W is disposed on the female terminal 10. In this situation, the core wire S of the electrical wire W is disposed on the wire barrel 31, and simultaneously the insulation portion H of the electrical wire W is disposed on the insulation barrel 32.

Then, the crimper 42 is made to move down as indicated by an arrow in FIG. 2, so that the wire barrel 31 of the female terminal 10 disposed on the mounting groove 43 in the anvil 41 is pressed from the upper side thereof by the crimper 42.

This permits both of the side walls 34a and 34b of the wire barrel 31 to be bent along the inner surface of the pressing groove 44 of the crimper 42.

In this situation, as described above, the female terminal 10 is mounted on the mounting groove 43 of the anvil 41, with the gap created between the bottom surface of the extending portion 31b in the wire barrel 31 and that of the second pressing portion 43b in the mounting groove 43. The pressing force, which is produced when the crimper 42 presses the wire barrel 31 and which is exerted from the anvil 41 to the extending portion 31b, is smaller than that exerted from the anvil 41 to the effective crimping portion 31a. Accordingly, as the wire barrel 31 of the female terminal 10 mounted on the mounting groove 43 of the anvil 41 is pressed by the crimper 42 from the upper side thereof, the extending portion 31b of the wire barrel 31 is deformed toward the above-described gap side.

Subsequently, when the crimper 42 reaches the bottom dead center, both of the side walls 34a and 34b in the effective crimping portion 31a of the wire barrel 31 are swaged as illustrated in FIG. 4, so the core wire S of the electrical wire W is crimped to the effective crimping portion 31a. Meanwhile, when the crimper 42 reaches the bottom dead center, both of the side walls 34a and 34b in the extending portion 31b of the wire barrel 31 are swaged as illustrated in FIG. 3 and FIG. 4. Also, at the same time, the bottom surface of the extending portion 31b is deformed downward along the bottom surface of the second pressing portion 43b of the mounting groove 43, so a swelling portion 45 is produced at the lower part of the extending portion 31b. That is to say, the draft amount of the extending portion 31b in the wire barrel 31 is made smaller than that of the effective crimping portion 31a. With this configuration, the core wire S of the electrical wire W is not crimped in the extending portion 31b, but the end portion of the core wire S is covered.

Next, after the crimping of the core wire S of the electrical wire W to the wire barrel 31 is completed, the position of the end portion of the core wire S in the wire barrel 31 is confirmed from the confirmation hole 33 of the extending portion 31b. Then, in a case where the end portion of the core wire S is not located on the front side of the rear end portion of the confirmation hole 33, there is a possibility that the core wire S is not crimped over the entire area of the effective crimping portion 31a in the wire barrel 31, in the inserting/extracting direction (the horizontal direction of FIG. 3). This is judged to be a defective crimp. Conversely, in a case where the end portion of the core wire S is located on the front side of the rear end portion of the confirmation hole 33, it is judged that crimping has been performed in an effective manner.

As described heretofore, the terminal crimping structure 1 illustrated in FIG. 3 and FIG. 4 is formed.

In the manner, in the terminal crimping device 40, the pressing force exerted from the anvil 41 to the extending portion 31b is set smaller than that exerted from the anvil 41 to the effective crimping portion 31a. This allows the core wire S of the electrical wire W to be crimped only in the effective crimping portion 31a of the wire barrel 31, whereas the core wire S is not crimped in the extending portion 31b because the swelling portion 45 is formed at the lower part of the extending portion 31b. Accordingly, the terminal crimping device 40 makes it possible to suppress the pressing force to be needed for crimping the core wire S of the electrical wire W to the wire barrel 31, and to suppress the reaction force exerted from the wire barrel 31 to the anvil 41 and the crimper 42. Therefore, the terminal crimping device 40 makes it possible to suppress the generation of the abrasion at the anvil 41 and the crimper 42, and simultaneously to prevent the generation of the upthrust portion at the upper part of the wire barrel 31 to which the core wire S of the electrical wire W is crimped.

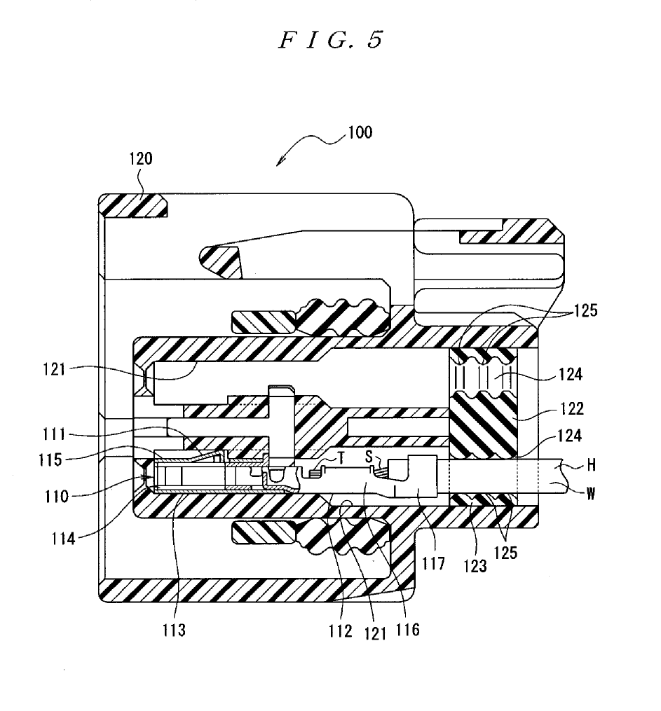

Additionally, in the terminal crimping structure 1, the extending portion 31b of the wire barrel 31 covers the end portion of the core wire S of the electrical wire W, thereby preventing the end portion of the core wire S from extruding frontward to be exposed from the wire barrel 31. Therefore, with the terminal crimping structure 1, it is possible to prevent the end portion of the core wire S from damaging the sealing member, when the female terminal 10 is inserted into the sealing member included in a connector housing of collective waterproof type such as the connector housing 120 shown in FIG. 5.

Herein, when the female terminal 10 having the terminal crimping structure 1 is included in an electrical connector, the female terminal 10 is secondarily locked by a retainer (not illustrated) to prevent the female terminal 10 from coming off from the connector housing (not illustrated). Then, when the female terminal 10 is locked by the retainer, the female terminal 10 is firstly inserted into the housing with the retainer disposed at a temporary locking position. In this case, the retainer is disposed above the wire barrel 31 of the female terminal 10 (the upper side of FIG. 3). Then, the retainer disposed at a temporary locking position is made to slide downward (to the lower side of FIG. 3) to be arranged at a proper locking position. In this situation, the front surface of a locking part in the retainer locks the rear surface of the retainer engaging portion 28 of the female terminal 10 to prevent the female terminal 10 from moving rearward. Accordingly, in a state where the retainer is arranged at the proper locking position, a space that corresponds to a sliding amount of the retainer that has been made to slide from the temporary locking position to the proper locking position is inevitably created below the wire barrel 31 of the female terminal 10. Meanwhile, in the terminal crimping structure 1, the swelling portion 45 is produced at the lower part of the extending portion 31b. Accordingly, in a case where the female terminal 10 is applied to an electrical connector, the swelling portion 45 is accommodated in the space inevitably created below the wire barrel 31. For this reason, the swelling portion 45 does not interfere with the retainer. Therefore, with the female terminal 10 having the terminal crimping structure 1, it is made possible for the retainer to lock the female terminal 10 with certainty, even when the female terminal 10 is applied to an electrical connector in which the arrangement pitch between the terminals is made small.

Furthermore, in an electrical connector (not illustrated) provided with the female terminals 10 each having the terminal crimping structure 1 and the connector housing (not illustrated) that secures the female terminals 10, the arrangement pitch between the female terminals 10 can be made small.

### INDUSTRIAL APPLICABILITY

According to a terminal crimping method or a terminal crimping device, a mounting groove of an anvil includes a first pressing portion that presses an effective crimping portion and a second pressing portion that presses an extending portion. The bottom surface of the second pressing portion is formed to be an inclined surface expanding and opening toward a receptacle portion side. This suppresses the generation of abrasion at the anvil and crimper, and simultaneously prevents the generation of an upthrust portion at the upper part of a wire barrel to which a core wire of an electrical wire is crimped.

In addition, a terminal crimping structure according to an aspect of the present invention is configured to produce a swelling portion at the lower part of the extending portion, thereby allowing a retainer to lock the terminal with certainty, even in a case where the terminal is applied to an electrical connector with a narrow arrangement pitch between the terminals.

Furthermore, the electrical connector according to an aspect of the present invention is provided with terminals to which the above terminal crimping structure is applied, whereby the arrangement pitch between the terminals can be made small.

1. A terminal crimping method comprising:
mounting a terminal on a mounting groove of an anvil, the terminal including a receptacle portion, an effective crimping portion that crimps a core wire of an electrical wire, and a wire barrel having an extending portion that covers an end portion of the core wire; and
pressing the wire barrel by use of a crimper,
the mounting groove including a first pressing portion that presses the effective crimping portion and a second pressing portion that presses the extending portion,
the bottom surface of the second pressing portion being formed to be an inclined surface expanding and opening toward the receptacle portion side.

2. A terminal crimping structure comprising a terminal including:
a receptacle portion having a retainer engaging portion that protrudes upward;
an extending portion that covers an effective crimping portion that crimps a core wire of an electrical wire, and an end portion of the core wire; and
a wire barrel that opens upward,
wherein:
the terminal is mounted on a mounting groove,
the core wire of the electrical wire is crimped to the wire barrel by pressing the wire barrel by use of a crimper,
the mounting groove includes a first pressing portion that presses the effective crimping portion and a second pressing portion that presses the extending portion,
the bottom surface of the second pressing portion is formed to be an inclined surface expanding and opening toward the receptacle portion side, so a swelling portion is formed at a lower part of the extending portion.

3. A terminal crimping device comprising:
an anvil having a mounting surface on which a terminal is mounted, the terminal including a receptacle portion, and a wire barrel having an effective crimping portion that crimps a core wire of an electric wire and an extending portion that covers an end portion of the core; and
a crimper that presses the wire barrel of the terminal mounted on the anvil,
the mounting groove including a first pressing portion that presses the effective crimping portion and a second pressing portion that presses the extending portion,
the bottom surface of the second pressing portion being formed to be an inclined surface expanding and opening toward the receptacle portion side.

4. An electrical connector comprising:
a terminal having the terminal crimping structure according to claim 2; and
a housing that secures the terminal.
